(19) United States
(12) Patent Application Publication
(10) Pub. No.: US 2007/0184300 A1
(43) Pub. Date: Aug. 9, 2007

(54) Oxygen absorbent molding and organic electroluminescent element

(75) Inventors: Emiko Yokose, Tokyo (JP); Jun Yokoyama, Tokyo (JP); Makoto Sumitani, Tokyo (JP)

Correspondence Address: NIXON PEABODY, LLP, 401 9TH STREET, NW, SUITE 900, WASHINGTON, DC, 20004-2128, US

(73) Assignee: Mitsubishi Gas Chemical Company, Inc., Chiyoda-ku, Tokyo (JP)

(21) Appl. No.: 10/584,297

(22) PCT Filed: Dec. 27, 2004
(86) PCT No.: PCT/JP04/19806

§ 371 Date: Jun. 23, 2006

(30) Foreign Application Priority Data
Dec. 26, 2003 (JP) 2003-433690
Feb. 25, 2004 (JP) 2004-049760

(51) Int. Cl. B32B 19/00

(52) U.S. Cl. 428/690

(57) ABSTRACT

An oxygen absorbent molding or a gas absorbent molding is provided. The oxygen absorbent molding is made of oxygen absorbent powder and a binder, and is characterized in that the binder is a fibrous resin. Fluororesin can be used as the fibrous resin. This oxygen absorbent molding has excellent oxygen-absorbing capability and mechanical strength and is suited for extending the life of an organic electroluminescent element.

### TECHNICAL FIELD

The present invention relates to an oxygen absorbent.

This invention also relates to a gas absorbent molding and an organic electroluminescent element using the gas absorbent molding.

The term “oxygen absorbent” used in this specification means an oxygen-absorbing composition that is solid or liquid at ordinary temperatures and contains an oxygen-absorbing component capable of absorbing oxygen by means of a chemical reaction. The term “oxygen absorbent powder” means an oxygen-absorbing composition in powder form that contains an oxygen-absorbing component in a solid state at ordinary temperatures, and a powder-form oxygen-absorbing composition made by having carrier powder carry or be impregnated with an oxygen-absorbing composition which contains an oxygen-absorbing component in a solid or liquid state at ordinary temperatures. The term “oxygen absorber” means a package of the oxygen absorbent. The term “binder” means a substance added to bind powder so that the powder can be easily formed into moldings.

### BACKGROUND ART

Oxygen absorbers are widely used to store goods such as foods that can be easily deteriorated by oxygen. Major oxygen absorbers that are now commercially available are oxygen absorbers in small air-permeable sachets that contain granular or powdery oxygen absorbents.

Various kinds of oxygen absorbing sheets whose form is different from the oxygen absorbers in small sachets, and which are made by dispersing an oxygen absorbent in a thermoplastic resin and molding the obtained mixture into sheet form have been suggested. For example, Patent Document 12 suggests a oxygen absorber made by blending an oxygen absorbent in a thermoplastic resin and molding the obtained mixture into sheet form. Patent Document 13 suggests a oxygen absorber made by blending an oxygen absorbent in an expandable resin, molding the obtained mixture into sheet form, and then making it expand. Patent Document 14 suggests a oxygen absorbing sheet which has multiple pores and is made by drawing a sheet made of an oxygen absorbent and a thermoplastic resin. Suggestions have been also made to use a oxygen absorbing sheet as a mat for foods or to use a oxygen absorber in tablet form by securing the oxygen absorbing tablets to the inside of a bottle cap.

Furthermore, the applicant of this invention suggests, in Patent Document 15, an oxygen absorbent molding in tablet form that is made by molding iron powder with a powder binder such as polyethylene or polypropylene.

In recent years, attention has been focused on an organic electroluminescent element, as a next-generation display device, that has superior characteristics such as high-speed response, high contrast, high luminance, wide viewing angle, and high precision.

However, the biggest problem of the organic electroluminescent element for practical use is that the element's light emitting life is short; particularly, the element's continuous operation life is short. The reason for the element's short life is considered to be that a slight amount of moisture and oxygen existing inside the element causes deterioration of electrode materials and organic compounds, thereby generating non-luminous parts (or dark spots) and resulting in degradation of the luminescent property.

Various methods have been suggested in order to prevent degradation caused by moisture and oxygen. For example, the following methods have been suggested: a method for joining, with an ultraviolet curable adhesive containing a desiccant, a substrate on which a luminescent structure is formed, and a protective glass plate (Patent Document 1); a method for sealing a luminescent structure with a sealing cap and securing a solid desiccant in the sealing cap (Patent Document 2); a method for securing a moisture absorbent molding in a sealing cap (Patent Document 3); a method for sealing a luminescent structure in an inert liquid (Patent Document 4); a method for sealing a luminescent structure with a plastic film on which silicon dioxide is deposited (Patent Document 5); and a method for sealing a luminescent structure with a plastic film on which silicon nitride is deposited (Patent Document 6). However, oxygen existing within the element and entering the element from outside cannot be removed completely by these methods.

The following methods are also disclosed: a method for filling a sealing cap with an oxygen adsorbent and a desiccant (Patent Document 7); a method for securing a sheet containing an oxygen adsorbent and a moisture absorbent (Patent Document 8); a method for sealing a luminescent structure in an inert liquid containing an oxygen absorbent and a desiccant (Patent Document 9); a method for laying an oxygen absorbing layer on the negative electrode side from between opposed electrodes (Patent Document 10); and a method for using a plastic film containing fine particles capable of effectively absorbing oxygen and moisture (Patent Document 11). However, the oxygen adsorbents used in the above-described methods are substances such as activated carbon, silica gel, and molecular sieves that can adsorb oxygen in a manner competing with moisture, or alkali earth metal compounds, and do not have sufficient oxygen-absorbing capability. It is also disclosed that powder or thin films of easily-oxidizing metal compounds or easily-oxidizing low-molecular organic compounds can be used as the oxygen absorbents. However, these oxygen absorbents have problems in that they do not exhibit sufficient oxygen-absorbing capability if moisture does not coexist; and the oxygen-absorbing speed of these oxygen absorbents is very slow under the dry conditions that are necessary inside the organic electroluminescent element.
(Patent Document 1) JP-A-5-290976
(Patent Document 2) JP-A-9-148066
(Patent Document 3) JP-A-2002-43055
(Patent Document 4) JP-A-5-129080
(Patent Document 5) JP-A-7-231114
(Patent Document 6) JP-A-2000-100469
(Patent Document 7) JP-A-11-329719
(Patent Document 8) JP-A-2002-280166
(Patent Document 9) JP-A-10-275682
(Patent Document 10) JP-A-7-169567
(Patent Document 11) JP-A-2002-56970
(Patent Document 12) JP-A-55-44344
(Patent Document 13) JP-A-56-26524
(Patent Document 14) JP-A-2-229840
(Patent Document 15) JP-A-4-244228

In the oxygen absorbers molded into sheet form having the oxygen absorbent dispersed in the resin as described in Patent Documents 12 to 14, the amount of resin in the sheet (on a weight basis or a volume basis) is larger than the amount of oxygen absorbent, and a large oxygen absorbent particle surface area is coated with the resin, and there is a limitation on contact between the oxygen absorbent and air or oxygen-containing gas. Therefore, the disadvantage of these oxygen absorbers is that their oxygen absorption capacity (the maximum oxygen absorption amount per unit weight or unit volume) is smaller and their oxygen absorption speed is slower than the oxygen absorbers in small sachets. The oxygen absorbent molding in tablet form described in Patent Document 15, which is produced by molding iron powder, using binder powder such as polyethylene or polypropylene, is publicly known. However, it was found that this oxygen absorbent molding has a problem in that it may break upon a strong impact. As a result of research with efforts focused on this problem, the inventors of the present invention found that since the powder molding mechanism depends mainly on adhesion between the oxygen absorbent particles and the binder particles to obtain an agglomerate of the oxygen absorbent particles, that aggregating power has its limits. Consequently, the inventors worked on development of an oxygen absorbent molding that can satisfy both oxygen-absorbing capability and mechanical strength, the conflicting capability requirements.

### DISCLOSURE OF THE INVENTION

It is a first object of the present invention to provide an oxygen absorbent molding that exhibits a high oxygen absorption speed and has a high oxygen absorption capacity and excellent mechanical strength to overcome the problem of conventional oxygen absorbent moldings.

It is a second object of the invention to provide a gas absorbent molding that can be easily secured within an organic electroluminescent element, and to provide an organic electroluminescent element made by combining the gas absorbent molding and a luminescent structure, wherein any moisture existing within or entering the sealed organic electroluminescent element can be promptly removed, and any oxygen existing within or entering the organic electroluminescent element in a dry atmosphere can be promptly removed, so that the life of the element can be extended.

As a result of thorough research to achieve the above-described objects, the inventors found that a molding of oxygen absorbent powder formed by using a fibrous resin as a binder can achieve the first object. Accordingly, they devised the invention.

The inventors also found that a gas absorbent molding formed from powder containing an oxygen absorbent [that has high oxygen-absorbing capability even in a dry atmosphere within an organic electroluminescent element] and a dehydrating agent in powder form [that exhibits a high moisture absorption speed], using a fibrous resin as a the binder, can achieve the second object. Accordingly, they devised the invention.

Specifically speaking, the invention relates to an oxygen absorbent molding made by binding oxygen absorbent powder with a fibrous resin. In particular, the invention relates to an oxygen absorbent molding made of oxygen absorbent powder and a binder, wherein the binder is a fibrous resin.

The invention also relates to a method for manufacturing an oxygen absorbent molding by: applying a shear force to and mixing a mixture of oxygen absorbent powder and a resin that can be fiberized by becoming subject to a shear force, at a temperature lower than a melting point of the resin; obtaining an agglomerate of the oxygen absorbent powder bound together by the fibrous resin; and then forming the agglomerate into the oxygen absorbent molding. Moreover, the invention relates to a method for manufacturing an oxygen absorbent molding by: applying a shear force to and mixing a mixture of carrier powder and a resin that can be fiberized by becoming subject to a shear force, at a temperature lower than a melting point of the resin; obtaining an agglomerate of the carrier powder bound together by the fibrous resin; and then having the carrier powder carry or be impregnated with an oxygen absorbent before or after pressure molding of the agglomerate.

Furthermore, the invention relates to a gas absorbent molding containing an oxygen absorbent and a dehydrating agent, wherein a composition containing the oxygen absorbent and the dehydrating agent is bound together by a fibrous resin fiberized by becoming subject to a shear force. The invention relates to an organic electroluminescent element having a luminescent structure made by stacking a transparent electrode, one or more organic compound layers containing an organic luminescent material, and a backside electrode, wherein the luminescent structure is sealed with a sealing component, and the gas absorbent molding described above is placed near the luminescent structure inside the organic electroluminescent element.

The oxygen absorbent molding according to the invention is a structure in which the oxygen absorbent powder is bound together and united by the fibrous resin. The fibrous resin is fibers of thermoplastic resin, and the diameter of each fiber is 0.01 to 100 μm. Since the oxygen absorbent molding is structured in the manner described above, the oxygen absorbent can be in direct contact with outside air even after it is formed into the molding, unlike a conventional molding in which the oxygen absorbent is dispersed in the thermoplastic resin. As a result, the oxygen absorption speed of the oxygen absorbent does not fall very much compared to its oxygen absorption speed before molding, and the oxygen absorbent powder can exhibit its original capability.

Moreover, unlike a conventional powder molding made by using a binder such as cellulose, polyvinyl alcohol, or polyethylene and having the particles to be molded bound with each other by means of adhesion between the particles and the binder, the particles to be molded are bound together by means of entanglement in the fibrous resin in the oxygen absorbent molding according to the invention. Therefore, the oxygen absorbent molding according to the invention has the advantages of high mechanical strength and easy handling because it does not break very much even under a strong impact.

A resin that is in fibrous form before being used for manufacture of the molding can be used as the fibrous resin. However, a resin that is fiberized by becoming subject to a shear force should preferably be used in terms of easy handling and the required capability. Fluororesin can be used as the fibrous resin.

The fibrous resin content in the oxygen absorbent molding according to the invention is 1 to 50 wt %. Since a small amount of fibrous resin is sufficient to effectively work as the binder, it is possible to increase the oxygen absorbent content in the oxygen absorbent molding and also increase the oxygen absorption capacity compared to a conventional molding in which the oxygen absorbent is dispersed in the thermoplastic resin.

The oxygen absorbent molding according to the invention can be prepared in sheet form. Alternatively, the oxygen absorbent molding according to the invention can be prepared in tablet form.

The principal oxidizing component of the oxygen absorbent powder used in the invention can be iron powder with its surface coated with metal halide or oxygen absorbent resin powder.

The principal oxidizing component of the oxygen absorbent powder used in the invention can also be carrier powder carrying or impregnated with at least one type of oxygen absorbent selected from the group consisting of ascorbic acid and its salts, polyhydric alcohol, unsaturated fatty acid compounds, and chain hydrocarbon polymers with an unsaturated group. Since the oxygen absorbent molding according to the invention does not necessarily require heating during its manufacturing process, an oxygen absorbent containing a low-heat-resistant compound as the principal oxidizing component can be used, unlike in a conventional molding manufactured by mixing oxygen absorbent powder and a resin in a molten state.

The oxygen absorbent molding according to the invention can be manufactured by applying a shear force to and mixing a mixture of oxygen absorbent powder and resin powder, obtaining an agglomerate of the oxygen absorbent powder bound together by the fibrous resin, and then molding the agglomerate by means of, for example, pressure molding.

The oxygen absorbent molding according to the invention can also be manufactured by having a carrier powder molding, in which carrier powder is bound together by a fibrous resin, carry or be impregnated with an oxygen absorbent. The expression “to carry” includes attaching the oxygen absorbent to the carrier powder molding or coating the carrier powder molding with the oxygen absorbent.

The invention also relates to a gas absorbent molding containing an oxygen absorbent and a dehydrating agent, wherein a component containing the oxygen absorbent and the dehydrating agent is held together by a fibrous resin. The oxygen absorbent molding according to the invention is a structure in which a composition made of the oxygen absorbent, the dehydrating agent, and an organic gas adsorbent (if necessary) is bound together and united by the fibrous resin. The fibrous resin is fibers of thermoplastic resin, and the diameter of each fiber is 0.01 to 5 μm.

A composition containing an organic compound with a tertiary carbon atom and/or an unsaturated group as its principal oxidizing component can be used as the oxygen absorbent for the gas absorbent molding. In particular, a composition containing, as its principal oxidizing component, an unsaturated fatty acid compound and/or a chain hydrocarbon polymer with an unsaturated group can be used as the oxygen absorbent.

The organic compound with a tertiary carbon atom and/or an unsaturated group, the unsaturated fatty acid compound, or the chain hydrocarbon polymer with an unsaturated group should preferably be carried by carrier powder.

At least one type selected from the group consisting of an alkali metal oxide, an alkali earth metal oxide, metal sulfate, and metal halide can be used as the dehydrating agent for the gas absorbent molding.

Calcium oxide with a specific surface area of 10 to 200 m²/g should preferably be used as the dehydrating agent.

The gas absorbent molding according to the invention can contain an organic gas adsorbent.

As the organic gas adsorbent, at least one type selected from the group of adsorbent solids with a large surface area such as activated carbon, zeolite, and diatomaceous earth can be used.

The fibrous resin content in the gas absorbent molding is 1 to 50 wt %, preferably 2 to 30 wt %. The oxygen absorbent content in the gas absorbent molding is 50 to 99 wt %, preferably 70 to 98 wt %.

The invention also relates to an organic electroluminescent element having a luminescent structure made by stacking a transparent electrode, one or more organic compound layers containing an organic luminescent material, and a backside electrode, wherein the luminescent structure is sealed with a sealing component, and a gas absorbent molding made by molding powder that contains an oxygen absorbent and a dehydrating agent is placed near the luminescent structure.

The invention provides an oxygen absorbent molding having superior oxygen-absorbing capability and mechanical strength. Specifically speaking, it is possible to provide an oxygen absorbent molding that involves a low risk of accidental ingestion and no risk of powder leakage, and exhibits superior oxygen-absorbing capability compared to that of a conventional oxygen absorbing sheet. In particular, the oxygen absorbent molding according to the invention exhibits an oxygen absorption speed equivalent to that of the oxygen absorber in a small sachet filled with the oxygen absorbent powder, and higher than that of a oxygen absorbing sheet made of an oxygen absorbent sheet. It is also possible to provide an oxygen absorbent molding that can be formed into any shape and having superior mechanical strength.

Since the inside of the organic electroluminescent element can be always maintained in a dry and anoxic state by using the oxygen absorbent molding or the gas absorbent molding according to the invention, the life of the luminescent element can be improved. In particular, the gas absorbent molding according to the invention can be easily secured inside the organic electroluminescent element, promptly remove moisture existing within or entering the sealed organic electroluminescent element, and also promptly remove oxygen existing within or entering the organic electroluminescent element in a dry atmosphere. Accordingly, the life of the organic electroluminescent element can be extended. The organic electroluminescent element with a long element life is provided by combining the gas absorbent molding according to the invention and the luminescent structure.

### BRIEF DESCRIPTION OF THE DRAWINGS

FIG. 1 is a schematic cross-sectional view of an example of the organic electroluminescent element according to the invention.

FIG. 2 is a schematic cross-sectional view of another example of the organic electroluminescent element according to the invention.

FIG. 3 is a schematic cross-sectional view of a further example of the organic electroluminescent element according to the invention.

FIG. 4 is a scanning electron microscope (SEM) photograph of an oxygen absorbent molding obtained in Example 1.

FIG. 5 is an SEM photograph of an oxygen absorbent molding obtained in Example 5.

FIG. 6 is a microscope photograph of the luminescent surface of an organic electroluminescent element obtained in Example 8 after 120 hours of constant-current continuous operation.

FIG. 7 is a microscope photograph of the luminescent surface of an organic electroluminescent element obtained in Comparative Example 3 after 120 hours of constant-current continuous operation.

### BEST MODE FOR CARRYING OUT THE INVENTION

The method for manufacturing the oxygen absorbent molding according to the invention will be first described below in detail. Then, the oxygen absorbent and the dehydrating agent used for the gas absorbent molding according to the invention will be described, and the gas absorbent molding and the organic electroluminescent element according to the invention will also be described.

A. Method for Manufacturing Oxygen Absorbent Molding

The most important thing in manufacturing the oxygen absorbent molding according to the invention is that a fibrous resin fiberized by becoming subject to a shear force is used as a binder. A resin that is already in fibrous form before it is used for manufacturing the molding can be used as the fibrous resin, but a thermoplastic resin that becomes fiberized when subject to a shear force at temperatures lower than the melting point of the resin should preferably be used because the resin is fiberized during the process of mixing the oxygen absorbent powder and the resin powder, entangles the oxygen absorbent powder, and holds the powder together, thereby resulting in a molding with high mechanical strength. An example of such a resin is fluororesin. Specific examples of the resin include: polytetrafluoroethylene (PTFE), tetrafluoroethylene-hexafluoropropylene copolymer (FEP), tetrafluoroethylene-perfluoro alkyl vinyl ether copolymer (PFA), polychloro-trifluoroethylene (PCTFE), polyvinylidene fluoride (PVDF), polyvinyl fluoride (PVF), and ethylene-tetrafluoroethylene copolymer (ETFE). Of these examples, PTFE should preferably be used. In particular, PTFE fine powder (mean diameter: 0.1 to 1 μm) manufactured by emulsion polymerization should preferably be used because its properties include easily releasing its folded molecular chains and assuming the form of soft and plastically deformable fibers when subject to a small shear force at a temperature of 20 degrees C. or higher.

The diameter of the fibrous resin in the oxygen absorbent molding according to the invention changes according to factors such as the strength of the shear force and compressive force applied to the resin, and the particle diameter of the oxygen absorbent powder particles used, and is 0.01 to 100 μm. In general, the larger the shear forced applied to the resin and the smaller the particle diameter of the oxygen absorbent powder used, the smaller the diameter of the fibrous resin becomes. The resin tends to easily agglutinate under pressure. Therefore, if a larger compressive force is applied to the resin during the process of mixing the oxygen absorbent powder and the resin, the fibrous resin agglutinates and the diameter of the fibrous resin increases. The diameter of the fibrous resin should preferably be 5 μm. A fibrous resin of 0.01 to 5 μm in diameter can function well as a binder for the oxygen absorbent powder used in the invention. If the diameter of the fibrous resin becomes larger than 5 μm, the number of fibrous resin fibers in the oxygen absorbent molding decreases and the weight of the resin necessary to obtain the molding tends to increase.

There is no particular limitation on the oxygen absorbent used in the invention, and any oxygen absorbent can be used as long as it is in powder form. Even if the oxygen absorbent is in its liquid state at room temperature, it can be used by having a powder carrier impregnated with that oxygen absorbent.

Examples for the oxygen absorbent are reduced metal powders such as iron, iron alloy, aluminum, and magnesium. Iron powder such as pure iron powder, cast iron powder, steel powder, and iron alloy powder is preferably used from the viewpoint of availability and safety. Iron powder coated with metal halide can preferably be used in order to enhance the oxygen-absorbing capability.

More examples of the oxygen absorbent are oxygen-absorbing resins. Specifically speaking, a powder-form resin composition made by adding a transition-metal catalyst to a thermoplastic resin having hydrogen atom(s) bound with tertiary carbon atom(s) is used as the oxygen-absorbing resin, and examples of such a powder-form resin composition include diene polymers (such as polybutadiene, polyisoprene, and polychloroprene), polypropylene, polyethylene, polyacrylic acid, ethylene-methyl acrylate copolymer, and hydrogenated styrene-butadiene rubber.

As a third group of examples of the oxygen absorbent, the following substances can be used: ascorbic acids and their salts; polyhydric alcohol such as glycerin, ethylene glycol, and propylene glycol; reducing sugar such as glucose, fructose, sorbitol, and xylose; and phenol compounds such as catechol, resorcin, hydroquinone, gallic acid, pyrogallol, and tocopherol. Also, unsaturated fatty acid compounds such as linolic acid, linolenic acid, linseed oil fatty acid, soybean oil fatty acid, and tall oil fatty acid, and chain hydrocarbon polymers with an unsaturated group such as liquid butadiene oligomer, liquid isoprene oligomer, liquid polybutadiene, liquid polyisoprpene, and liquid styrene-butadiene rubber can be used. These oxygen absorbents can be used as oxygen absorbent powder, in order to manufacture the molding, by having carrier powder carry or be impregnated with the oxygen absorbents. There is no particular limitation on the carrier as long as it has a large specific surface area so that a large contact area between the oxygen absorbent and any oxygen will be ensured. Examples of the carrier include silica, alumina, magnesia, titania, calcium silicate, activated carbon, zeolite, diatomaceous earth, and clay mineral.

Regarding the particle diameter of the oxygen absorbent, finer particles are preferably used because the fine oxygen absorbent particles can be easily held in the net structure formed by the fibrous resin. Specifically speaking, the mean diameter of the oxygen absorbent is preferably 0.05 to 100 μm, more preferably 0.1 to 50 μm.

A desiccant and/or a gas adsorbent can also be added, as necessary, to the oxygen absorbent molding used in the invention.

The desiccant should preferably be capable of keeping a solid state even after adsorbing moisture. Examples of the desiccant include: various kinds of zeolite such as silica gel and alumina; alkali earth metal oxides such as magnesium oxide, calcium oxide, and barium oxide; sulfates such as sodium sulfate, magnesium sulfate, and calcium sulfate; and alkali earth metals such as calcium and barium.

As the gas adsorbent, the following substances can be used: synthetic zeolite such as zeolite 5A, Y, and 13X; natural zeolite such as mordenite, erionite, and faujasite; and activated carbons manufactured from various raw materials.

Regarding the particle diameter of the desiccant and the adsorbent, finer particles are preferably used because the fine particles of the desiccant and/or the adsorbent can be easily held in a net structure formed by the fibrous resin. Specifically speaking, the mean diameter of the desiccant or the adsorbent is preferably 0.05 to 100 μm, more preferably 0.1 to 50 μm.

In order to manufacture the oxygen absorbent molding according to the invention, first the oxygen absorbent powder and the resin that can be fiberized when subject to a shear force are mixed together at a temperature lower than the melting point of the resin. There is no particular limitation on the mixing method as long as the shear force is applied; for example, the oxygen absorbent powder and the resin can be mixed in a mortar. Examples of a machine suited to mixing on an industrial scale include stone mills (automatic mortars), ball mills, roll mills, screw kneaders, planetary mixers, Banbury mixers, and extruders. The type of the oxygen absorbent to be used is not limited. If it is difficult to mix the mixture containing only the oxygen absorbent powder and the resin, a solvent such as alcohol, solvent naphtha, liquid paraffin, glycerin, ethylene glycol, olive oil, and silicon oil may be used as a mixing assistant to make the mixture plastically deform to a moderate degree. It is important to set the mixing temperature lower than the melting point of the resin. The lowest temperature from among the melting point of the resin, the boiling point of the oxygen absorbent, and the decomposition temperature of the oxygen absorbent should be set as the upper limit for the mixing temperature, and the best temperature should be selected according to the type of the oxygen absorbent and the resin to be used, and the mixing method. The mixing temperature may be room temperature. If the temperature is maintained below the above-described upper limit, the mixture can be mixed without any thermostat. However, the mixing temperature should preferably be controlled by providing heating or cooling equipment.

As a shear force is repeatedly applied to the oxygen absorbent powder and the resin during the process of mixing the oxygen absorbent powder and the resin, the resin becomes fiberized and entangles the oxygen absorbent powder, thereby binding the oxygen absorbent powder together and obtaining an agglomerate of the oxygen absorbent powder. If insufficient shear force acts, the fibers will develop insufficiently and cause the oxygen absorbent powder molding to fall apart.

A preferred range of fibrous resin content in the oxygen absorbent molding according to the invention depends on the type of oxygen absorbent used and the oxygen-absorbing capability and mechanical strength required for the molding, and can preferably be 1 to 50 wt %, more preferably 2 to 30 wt %. If the fibrous resin content is less than 1 wt %, the entanglement of the fibrous resin will be poor and the oxygen absorbent powder will easily fall apart. If the fibrous resin content is more than 50 wt %, the oxygen absorbent content in the oxygen absorbent molding decreases and the oxygen-absorbing capability is impaired, which is undesirable.

The oxygen absorbent molding according to the invention can also be manufactured by using carrier powder instead of the oxygen absorbent powder used in the manufacturing method described above, making a molding of the carrier powder in which the carrier powder is bound by the fibrous resin, and then having the carrier powder molding carry or be impregnated with an oxygen absorbent. If such a method is employed, even an oxygen absorbent not easily able to be formed into a mixture suited for molding because of, for example, a high moisture content, can be used to manufacture a molding. Since it is only necessary to change the kind of oxygen absorbent to be carried or used for impregnation, this method has the advantage of easy switchability between manufactured molding types.

There is no particular limitation on the shape of the oxygen absorbent molding according to the invention, and the oxygen absorbent molding can be made in any desired shape, such as a sheet, tablet, bar, strip, or tubular (hollow cylindrical) shape. A sheet-form molding can be manufactured by rolling the agglomerate of the oxygen absorbent powder and the fibrous resin obtained by the manufacturing method described above into a desired thickness. A tablet-form molding can be manufactured by compression molding of the mixture, using a tableting machine. A bar-form, strip-form, or tubular molding can be manufactured by extrusion molding of the mixture, using a die of relevant shape.

B. Oxygen Absorbent Used in Gas Absorbent Molding

The oxygen absorbent that exhibits a high oxygen-absorbing capability even in a dry atmosphere and is used for the gas absorbent molding according to the invention contains, as its principal oxidizing component, an organic compound with an unsaturated group or a tertiary carbon atom.

As the organic compound with an unsaturated group, an unsaturated fatty acid compound or a polymer with an unsaturated group, or a combination of both is used. Examples of the unsaturated fatty acid compound include: unsaturated fatty acids such as linolic acid, linolenic acid, arachidonic acid, parinaric acid, and dimer acid; metal salts of the unsaturated fatty acids; and fats and oils esterified to these unsaturated fatty acids. Examples of the unsaturated fatty acid include fatty acids obtained from vegetable oils and animal oils, including linseed oil fatty acid, soybean oil fatty acid, China wood oil fatty acid, rice bran oil fatty acid, sesame oil fatty acid, cotton seed oil fatty acid, rapeseed oil fatty acid, and tall oil fatty acid.

Chain hydrocarbon polymers should preferably be used as the polymer with an unsaturated group. Examples of the chain hydrocarbon polymer are liquid oligomers and polymers of various molecular weights such as liquid butadiene oligomer, liquid butadiene polymer, liquid isoprene oligomer, liquid isoprene polymer, squalene, liquid acetylene oligomer, liquid pentadiene oligomer, liquid oligo-ester-acrylate, liquid butene oligomer, liquid BR, liquid SBR, liquid NBR, liquid chloroprene oligomer, liquid sulfide oligomer, liquid isobutylene oligomer, liquid butyl rubber, liquid cyclopentadiene petroleum resin, liquid oligo-styrene, liquid hydroxyl polyolefin oligomer, liquid alkyd resin, liquid unsaturated polyester resin, and natural rubber.

The unsaturated fatty acid compound and/or the chain hydrocarbon polymer with an unsaturated group do not always have to be a single substance, and may be a mixture or a copolymer of two or more substances. A small amount of impurities such as solvents mixed in the unsaturated fatty acid compound or the chain hydrocarbon polymer during their manufacturing process can be used to the extent desirable. Also, these compounds may have a substituent group other than an unsaturated group.

As the organic compound with an unsaturated group, an organic compound containing cycloolefin, such as cyclopentene or cyclohexene, in its structure can be used. Examples of such an organic compound include 3-cyclohexene-1-methanol, 3-cyclohexene-1-carboxylic acid and their salts, polymers made by grafting the aforementioned compounds, and poly(metha)acrylic acid and ethylene-methyl (metha)acrylate copolymer with which 3-cyclohexene-1-methanol is bound by ester exchange.

As the organic compound with a tertiary carbon atom, organic high molecular compounds with a hydrogen atom(s) bound with a tertiary carbon atom(s) are used, including polystyrene, polybutene, polyvinyl alcohol, poly(metha)acrylic acid, poly methyl (metha)acrylate, poly(metha)acrylamide, poly(metha)acrylonitrile, polyvinyl acetate, polyvinyl chloride, polyvinyl fluoride, ethylene-vinyl acetate copolymer, ethylene-ethyl (metha)acrylate copolymer, ethylene (metha)acrylate copolymer, ethylene-methyl (metha)acrylate copolymer, acrylic rubber, polymethylpentene, polypropylene, ethylene propylene rubber, ethylene-1-butene rubber, butyl rubber, and hydrogenated styrene-butadiene rubber.

An oxygen absorption accelerating substance can be added as an assistant to the oxygen absorbent according to the invention in order to accelerate oxygen absorption caused by oxidation of the principal oxidizing component. At least one type of oxygen absorption accelerating substance selected from the group consisting of Cu, Fe, Co, Ni, Cr, Mn, Ca, Pb, Zn, and their compounds is used as the oxygen absorption accelerating substance. Examples of the oxygen absorption accelerating substance include: inorganic salts such as sulfates, chlorides, and nitrates; fatty acid salts such as stearic acid salts, naphthenic acid salts, octylic acid salts, and rhodinic acid salts; organic salts such as acetylacetonate metal salts; and metal alkyl compounds. From among Cu, Fe, Co, Ni, Cr, Mn, Ca, Pb, and their compounds, Mn and Co salts should preferably be used because they are highly active in terms of their oxygen absorption accelerating capability.

The oxygen absorbent may be either a solid composition or a liquid composition. In the case of a liquid composition, a dehydrating agent or an organic gas adsorbent can be impregnated with the liquid composition. The form of the oxygen absorbent can be different from the form of the dehydrating agent. However, a composition in which the oxygen absorbent and the dehydrating agent are united by having the dehydrating agent impregnated with the oxygen absorbent, which is composed of a liquid principal oxidizing component and an assistant, should preferably be used. The amount of oxygen absorbent to be used is the amount of oxygen absorbent necessary to maintain the system atmosphere in a substantially oxygen-free condition during at least its design life period, and should preferably be an amount of oxygen absorbent allowing the absorption of 1.1 to 10 times as much oxygen as the amount of oxygen in the system atmosphere.

A preferred range for the oxygen absorbent content in the oxygen absorbent molding according to the invention depends on the type of the oxygen absorbent used and the oxygen-absorbing capability and mechanical strength required for the molding, and can be 50 to 99 wt %, more preferably 70 to 98 wt %. If the oxygen absorbent content is less than 50 wt %, the amount of oxygen absorbent in the oxygen absorbent molding decreases and its oxygen-absorbing capability is impaired. If the oxygen absorbent content is more than 99 wt %, the oxygen absorbent powder will easily fall apart.

C. Dehydrating Agent Used for Gas Absorbent Molding

The dehydrating agent used for the gas absorbent molding according to the invention should preferably be the type capable of chemically adsorbing moisture and maintaining its solid state even after adsorbing moisture. Examples of the dehydrating agent include: alkali metal oxides such as sodium oxide and potassium oxide; alkali earth metal oxides such as magnesium oxide, calcium oxide, strontium oxide, and barium oxide; sulfates such as sodium sulfate, magnesium sulfate, and calcium sulfate; and metallic halides such as calcium chloride, magnesium chloride, and iron chloride. The above-listed dehydrating agent may be used alone, or a mixture of two or more dehydrating agents may be used. Other than the substances listed above, metal alkoxides such as aluminum trioctyl oxide and aluminum oxide-2-ethyl-hexanoate can also be used as the dehydrating agent according to the invention.

The mean primary particle diameter of the dehydrating agent should be 10 μm or less, preferably 1 μm or less. If the mean primary particle diameter is larger than 10 μm, the moisture absorption speed becomes slow and, therefore, such a dehydrating agent is not suitable for practical use. Also, the adsorbent powder will easily fall apart from the molding.

If a particularly high moisture absorption speed is required, an alkali earth metal oxide with a specific surface area of 10 to 200 m²/g, obtained by calcining a hydroxide or carbonate of an alkali earth metal with a mean primary particle diameter of 1 μm or less, in vacuum or in a dry nitrogen gas flow at a temperature of 350 to 800 degrees C. Among the alkali earth metal oxides, calcium oxide should more preferably be used in terms of safety, cost, and other factors. Calcium oxide is the preferred dehydrating agent also because it acts to promote oxygen absorption by the oxygen absorbent according to the invention; however, the mechanism of that action is unknown.

According to the invention, an organic gas adsorbent can also be used as appropriate. As the organic gas adsorbent, the following substances can be used: synthetic zeolite such as zeolite 5A, Y, and 13X; natural zeolite such as mordenite, erionite, and faujasite; and activated carbons manufactured from various raw materials. Adding the organic gas adsorbent to the gas absorbent molding makes it possible to obtain a molding that has, in addition to the oxygen removal function and the moisture removal function, the function of removing various organic gases that may degrade the performance of the organic electroluminescent element.

D. Gas Absorbent Molding

Since the gas absorbent molding according to the invention (hereinafter sometimes referred to as the “molding”) is molded in a manner unlike conventional oxygen absorbents and moisture absorbents in powder form, the molding can be easily secured inside an organic electroluminescent element, using, for example, an adhesive tape or an adhesive.

Moreover, the gas absorbent molding according to the invention is structured in such a manner that it can maintain the original capabilities of the oxygen absorbent and the dehydrating agent. Specifically speaking, the gas absorbent molding according to the invention is structured so that powder containing the oxygen absorbent and the dehydrating agent is bound by the very fine fibrous resin. Since the gas absorbent molding has the above-described structure, unlike conventional moldings made by dispersing an oxygen absorbent and/or a dehydrating agent in a thermoplastic resin, the oxygen absorbent and the dehydrating agent in their entirety can be in direct contact with outside air even after they are formed into the molding. Therefore, it is possible to manufacture the molding without degrading the original capabilities of the oxygen absorbent and the dehydrating agent. Furthermore, unlike conventional powder moldings made using a binder such as cellulose or polyvinyl alcohol and having the particles to be molded held together by means of adhesion between those particles and the binder particles, the particles to be molded in the molding according to the invention are held together by entanglement in the fibrous resin. Therefore, the oxygen absorbent molding according to the invention is characterized by its high mechanical strength and easy handling because it does not break very much even under a strong impact.

There is no particular limitation on the form of the gas absorbent molding according to the invention, and the gas absorbent molding is used in sheet form, tablet form, or other forms, according to the type of usage. In particular, if the organic electroluminescent element is used as a small display for devices such as cell phones, digital still cameras, and personal digital assistants (PDA), it is desirable that the gas absorbent molding in sheet-form with a thickness of 40 to 400 μm, preferably 100 to 300 μm, be used.

As the fibrous resin used for the gas absorbent molding according to the invention, a resin that becomes fiberized by becoming subject to a shear force should preferably be used because the fibers develop during the process of mixing the powder containing the oxygen absorbent and the dehydrating agent, entangle the powder containing the oxygen absorbent and the dehydrating agent, and hold the powder together, thereby resulting in a molding with high mechanical strength. An example of such a resin is fluororesin. Specific examples of the resin include: polytetrafluoroethylene (PTFE), tetrafluoroethylene-hexafluoropropylene copolymer (FEP), tetrafluoroethylene-perfluoro alkyl vinyl ether copolymer (PFA), polychloro-trifluoroethylene (PCTFE), polyvinylidene fluoride (PVDF), polyvinyl fluoride (PVF), and ethylene-tetrafluoroethylene copolymer (ETFE). Of these examples, PTFE should preferably be used. In particular, PTFE fine powder (mean diameter: 0.1 to 1 μm) manufactured by emulsion polymerization should preferably be used because its properties include easily releasing its folded molecular chains and assuming the form of soft and plastically deformable fibers when subject to a small shear force at a temperature of 20 degrees C. or higher.

The diameter of the fibrous resin in the gas absorbent molding according to the invention changes according to factors such as the strength of the shear force and compressive force applied to the resin, and the particle diameter of the powder containing the oxygen absorbent and the dehydrating agent to be used, and should be 0.01 to 5 μm. In general, the larger the shear forced applied to the resin and the smaller the particle diameter of the powder containing the oxygen absorbent and the dehydrating agent to be used, the smaller the diameter of the fibrous resin becomes. The resin tends to easily agglutinate under pressure. Therefore, if a larger compressive force is applied to the resin during the process of mixing the oxygen absorbent powder and the resin, the fibrous resin agglutinates and the diameter of the fibrous resin increases.

A preferred range for the fibrous resin content in the gas absorbent molding according to the invention depends on the type of the oxygen absorbent and the dehydrating agent to be used, and the oxygen-absorbing capability, the moisture-absorbing capability, and the mechanical strength required for the molding, and is preferably 1 to 50 wt %. If the fibrous resin content is less than 1 wt %, the entanglement of the fibrous resin will be poor and the powder containing the oxygen absorbent and the dehydrating agent will easily fall apart. If the fibrous resin content is more than 50 wt %, the oxygen absorbent content and the dehydrating agent content in the molding decrease and the oxygen and moisture absorbing capability is impaired, which is undesirable.

In order to manufacture the gas absorbent molding according to the invention, first the powder containing the oxygen absorbent and the dehydrating agent, and the resin powder are mixed together under conditions where the resin will not melt. There is no particular limitation on the mixing method as long as the shear force is applied; for example, the powder containing the oxygen absorbent and the dehydrating agent, and the resin can be mixed in a mortar. Examples of a machine suited to mixing on an industrial scale include stone mills (automatic mortars), ball mills, roll mills, screw mixers, planetary mixers, Banbury mixers, and extruders. If it is difficult to mix the mixture made of only the powder, which contains the oxygen absorbent and the dehydrating agent, and the resin, a solvent such as alcohol, solvent naphtha, liquid paraffin, glycerin, ethylene glycol, olive oil, and silicon oil may be used as a mixing assistant to make the mixture plastically deform to a moderate degree. Concerning the mixing temperature, the lowest temperature from among the melting point of the resin, the boiling point of the oxygen absorbent, and the decomposition temperature of the oxygen absorbent should be set as the upper limit for the mixing temperature, and the best temperature should be selected as the mixing temperature according to the type of the oxygen absorbent, the dehydrating agent, and the resin to be used, and the mixing method.

As a shear force is repeatedly applied to the powder, which contains the oxygen absorbent and the dehydrating agent, and the resin during the process of mixing the powder, which contains the oxygen absorbent and the dehydrating agent, and the resin, the resin becomes fiberized and the powder containing the oxygen absorbent and the dehydrating agent becomes held by the very fine fibrous resin. If the insufficient shear force acts, the fibers will develop insufficiently and cause the molding of the powder containing the oxygen absorbent and the dehydrating agent to fall apart. In other words, the mixing process is a very important step, and optimum mixing conditions can be determined by repeated trials.

The proportion of the oxygen absorbent to the dehydrating agent in the molding is set according to the oxygen-absorbing capability and the moisture-absorbing capability required for the molding. If a high oxygen-absorbing capability is required, the proportion of the oxygen absorbent to the dehydrating agent should be increased. If a high moisture-absorbing capability is required, the proportion of the oxygen absorbent to the dehydrating agent should be decreased.

The molding can be manufactured by, for example, press molding, extrusion molding, or rolling.

E. Organic Electroluminescent Element

The gas absorbent molding and the organic electroluminescent element according to the invention are described below with reference to the relevant drawings.

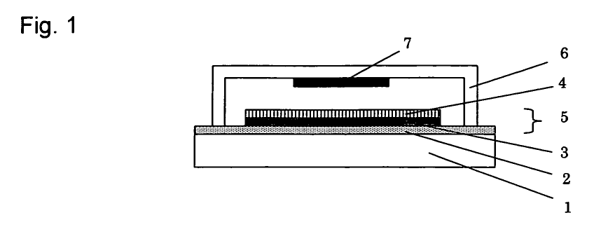

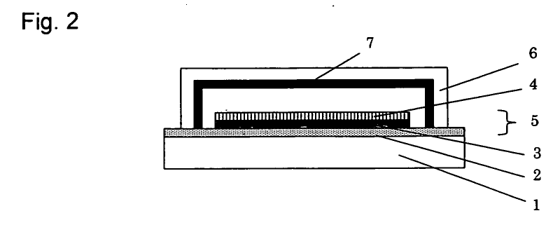

FIG. 1 is a schematic cross-sectional view of the organic electroluminescent element according to a first embodiment of the invention. This organic electroluminescent element includes a luminescent structure 5 in which an ITO transparent electrode 2 is formed as a positive electrode on a glass substrate 1, an organic compound layer 3 containing an organic luminescent material is formed on the transparent electrode 2, and a metal electrode 4 is formed as a negative electrode on the organic compound layer 3. The luminescent structure 5 is sealed with a sealing cap 6. A gas absorbent molding 7 according to the invention is secured to the inside surface of the sealing cap. A method for securing the gas absorbent molding 7 is not limited, and the gas absorbent molding 7 can be secured by using, for example, an adhesive tape or an adhesive. There is no particular limitation on the size of the gas absorbent molding 7 as long as the gas absorbent molding 7 is large enough to exhibit sufficient oxygen removal. The gas absorbent molding 7 can be used to cover not only a partial area of the inside surface of the sealing cap as shown in FIG. 1, but also the entire inside surface of the sealing cap as shown in FIG. 2.

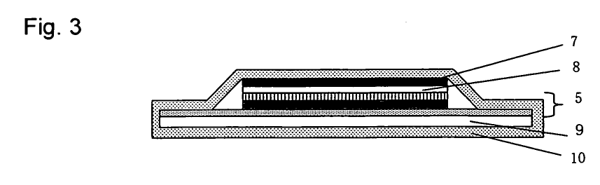

FIG. 3 is a schematic cross-sectional view of the organic electroluminescent element according to a second embodiment of the invention. In this organic electroluminescent element, the luminescent structure 5 is formed on a transparent film substrate made of a highly-gas-impermeable plastic film or a flexible resin-reinforced ultrathin glass, and an insulation protection film 8 made of a metal oxide such as silicon dioxide is formed on the luminescent structure 5. The highly-gas-impermeable plastic film or the flexible resin-reinforced ultrathin glass is also used to seal the element, and the gas absorbent molding 7 according to the invention is secured to the inside surface of the sealing film.

### EXAMPLES

The invention will be described in further detail by referring to the examples below. However, the invention is not limited to these examples.

### Example 1

Oxygen absorbent powder was obtained by mixing 1000 g of reduced iron powder (mean diameter: 50 μm) and 50 g of 50 wt % calcium chloride in aqueous solution, drying the obtained mixture, and then screening the dried mixture to remove coarse particles.

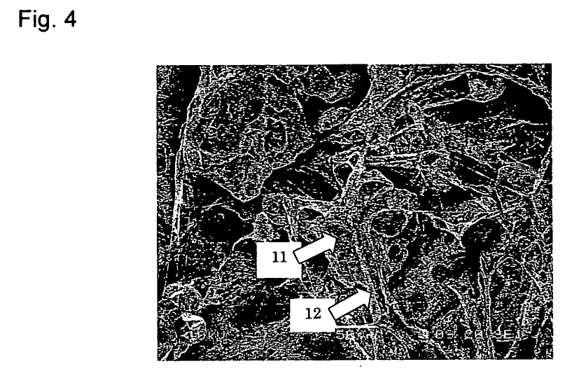

Subsequently, 3.0 g of this oxygen absorbent powder was mixed with 0.158 g of PTFE powder (product name “6-J”; manufactured by DU PONT-MITSUI FLUOROCHEMICALS COMPANY, LTD; melting point of 332 degrees C.) (weight ratio of the oxygen absorbent powder:PTFE=95:5), and the mixture was mixed well at room temperature (about 28 degrees C.), using a mortar. The obtained agglomerate was rolled into a sheet-form oxygen absorbent molding A (thickness: 300 μm). FIG. 4 shows a scanning electron microscope (SEM) photograph of the oxygen absorbent molding A. The oxygen absorbent molding A is a structure in which the oxygen absorbent powder containing the reduced iron powder as its principal oxidizing component is bound together and united by the thermoplastic resin fibers (diameter: approximately1 μm to 50 μm).

An area of size 3 cm×3 cm (0.81 g) of the oxygen absorbent molding A was cut out. The cutout piece of the oxygen absorbent molding A was put, together with 2000 ml of air and a humidity control material (absorbent cotton made wet with 10 g of water), in an oxygen-impermeable bag, which was then sealed. The oxygen absorbent molding A in the oxygen-impermeable bag was stored at a temperature of 25 degrees C. The oxygen concentration within the bag was measured by gas chromatograph, and the initial oxygen absorption speed and the maximum oxygen absorption amount were measured on an oxygen absorbent powder weight basis. The “initial oxygen absorption speed on an oxygen absorbent powder weight basis” means the oxygen absorption amount (ml/g-powder/day) per 1 g of oxygen absorbent powder contained in the molding after a lapse of one day from the start of oxygen absorption. The “maximum oxygen absorption amount on an oxygen absorbent powder weight basis” means the oxygen absorption amount (ml/g-powder) per 1 g of oxygen absorbent powder contained in the molding at the earliest point in time when the oxygen absorbent molding becomes no longer capable of absorbing any more oxygen. If these values are equivalent to those of the oxygen absorbent in a small sachet, it means that the oxygen-absorbing capability of the oxygen absorbent powder itself is not impeded by molding the oxygen absorbent powder.

[Control 1]

Oxygen absorbent B in a small sachet made by putting 0.80 g of oxygen absorbent powder prepared in the same manner as in Example 1 in an air-permeable sachet was put, together with 2000 ml of air and the humidity control material, in an oxygen-impermeable bag, which was then sealed. Subsequently, the initial oxygen absorption speed and the maximum oxygen absorption amount on an oxygen absorbent powder weight basis were measured in the same manner as in Example 1. Table 1 shows the results.

The oxygen absorption speed and the maximum oxygen absorption amount of the oxygen absorbent molding A on an oxygen absorbent powder weight basis were quite greater than those of the oxygen absorbent B in the small sachet. In the case of Control 1, as the oxygen absorbent powder prepared in Example 1 absorbs oxygen, it has the property of consolidating in the areas around the powder surfaces and becoming a hard agglomerate, thereby hindering diffusion of oxygen into the agglomerate and degrading the oxygen-absorbing capability. Also, the oxygen absorption speed and the maximum oxygen absorption amount of the oxygen absorbent molding A in Example 1 turned out to be higher than those of the oxygen absorbent B in the small sachet, presumably because the fibrous resin is in the gaps between the oxygen absorbent powder particles and, therefore, prevents consolidation of the powder particles.

### Comparative Example 1

A sheet (thickness: 600 μm) was obtained by mixing 700 g of oxygen absorbent powder prepared in the same manner as in Example 1 and 300 g of polyethylene, heating, melting and mixing the mixture at a temperature of 190 degrees C., and performing T-die molding of the mixture, using an extruder. This sheet was drawn in a longitudinal direction, using a roll drawing machine, thereby obtaining sheet-form oxygen absorbent molding C (thickness: 300 μm). An area of size 3 cm×3 cm (0.28 g) of the oxygen absorbent molding C was cut out. The cutout piece of the oxygen absorbent molding C was put, together with 500 ml of air and the humidity control material, in an oxygen-impermeable bag, which was then sealed. The initial oxygen absorption speed (mug-powder/day) on an oxygen absorbent powder weight basis, and the maximum oxygen absorption amount (ml/cm²-molding) on a molding area basis were measured. Table 2 shows the results. The initial oxygen absorption speed of the oxygen absorbent molding C on an oxygen absorbent powder weight basis was ½ of that of the oxygen absorbent molding A in Example 1. This result shows that the oxygen absorption by the oxygen absorbent powder itself was impeded. The maximum oxygen absorption amount of the molding C on a molding area basis was ⅕ of that of the oxygen absorbent molding A.

### Example 2

Oxygen absorbent powder was obtained by dissolving 60 g of FeSO₄.7H₂O and 100 g of Na₂CO₃.10H₂O in 45 wt % sodium L-ascorbate in aqueous solution, and impregnating 600 g of activated carbon powder (mean diameter: 10 μm) with the full amount of the above-obtained solution.

Subsequently, 0.85 g of the oxygen absorbent powder obtained above was mixed with 0.15 g of PTFE powder (product name “POLYFLON F-104”; manufactured by DAIKIN INDUSTRIES, LTD.) (weight ratio of the oxygen absorbent powder:PTFE=85:15), and the mixture was mixed well at room temperature, using a mortar. The obtained agglomerate was rolled into sheet-form oxygen absorbent molding D (thickness: 300 μm). An area of size 3 cm×6 cm (0.63 g) of the oxygen absorbent molding D was cut out. The cutout piece of the oxygen absorbent molding D was put, together with 800 ml of air, in an oxygen-impermeable bag, which was then sealed. The oxygen absorbent molding D in the oxygen-impermeable bag was stored in a 60% RH atmosphere at a temperature of 25 degrees C. The initial oxygen absorption speed and the maximum oxygen absorption amount on an oxygen absorbent powder weight basis were measured in the same manner as in Example 1. Table 1 shows the results.

### Example 3

In this example, 0.9 g of the oxygen absorbent powder prepared in the same manner as in Example 2 was mixed with 0.1 g of the same PTFE powder as used in Example 2 (weight ratio of the oxygen absorbent powder:PTFE=90:10), and the mixture was well mixed at room temperature (about 25 degrees C.), using a mortar. Then, a tablet machine (diameter: 12 mm) was filled with 0.82 g of the obtained agglomerate and compression molding was performed at a pressure of 1 t/cm², thereby obtaining tablet-form oxygen absorbent molding E (each tablet being 12 mm in diameter and 7.2 mm high). This oxygen absorbent molding E was put, together with 800 ml of air, in an oxygen-impermeable bag, which was then sealed. The oxygen absorbent molding E in the oxygen-impermeable bag was stored in a 60% RH atmosphere at a temperature of 25 degrees C. The initial oxygen absorption speed and the maximum oxygen absorption amount on an oxygen absorbent powder weight basis were measured in the same manner as in Example 1. Table 1 shows the results.

When 50 tablets of the oxygen absorbent molding E were allowed to freely fall from a height of 2 m down to a concrete floor, none of the oxygen absorbent molding tablets cracked or chipped.

[Control 2]

Oxygen absorbent F in a small air-permeable sachet containing 0.98 g of oxygen absorbent powder prepared in the same manner as in Example 2 was put, together with 800 ml of air, in oxygen-impermeable bag, which was then sealed. The initial oxygen absorption speed and the oxygen absorption amount on an oxygen absorbent powder weight basis were measured in the same manner as in Example 1. Table 1 shows the results.

The initial oxygen absorption speed and the maximum oxygen absorption amount of the oxygen absorbent molding D (Example 2) and the oxygen absorbent molding E (Example 3) on an oxygen absorbent powder weight basis were equivalent to those of the oxygen absorbent F in the small sachet. Therefore, it is apparent that the oxygen-absorbing capability of the oxygen absorbent powder itself is not impeded even if it is molded into the moldings D and E.

### Example 4

A homogeneous solution was obtained by mixing 12.5 g of liquid butadiene oligomer and 0.31 g of manganese naphthenate. The full amount of this solution was carried by 40 g of natural zeolite powder (mean diameter: 10 μm), and 40 g of calcium oxide powder (mean diameter: 1 μm) was then added to the natural zeolite powder carrying the above solution, thereby obtaining oxygen absorbent powder.

Subsequently 0.90 g of the oxygen absorbent powder obtained above was mixed with 0.10 g of PTFE powder (product name “Fluon CD-1”; manufactured by ASAHI GLASS CO., LTD.; melting point of 332 degrees C.) (weight ratio of the oxygen absorbent powder:PTFE=90:10), and the mixture was well mixed at room temperature (about 25 degrees C.), using a mortar. Then, a tablet machine (diameter: 12 mm) was filled with 1.41 g of the obtained agglomerate and compression molding was performed at a pressure of 1 t/cm², thereby obtaining tablet-form oxygen absorbent molding G (each tablet being 12 mm in diameter and 8.0 mm high). This oxygen absorbent molding G was put, together with 800 ml of air, in an oxygen-impermeable bag, which was then sealed. The oxygen absorbent molding G in the oxygen-impermeable bag was stored at a temperature of 25 degrees C. The initial oxygen absorption speed and the oxygen absorption amount on an oxygen absorbent powder weight basis were measured in the same manner as in Example 1. Table 1 shows the results.

[Control 3]

Oxygen absorbent H in a small sachet made by putting 1.50 g of oxygen absorbent powder prepared in the same manner as in Example 4 in the air-permeable sachet was put, together with 800 ml of air, in an oxygen-impermeable bag, which was then sealed. The initial oxygen absorption speed and the oxygen absorption amount on an oxygen absorbent powder weight basis were measured in the same manner as in Example 1. Table 1 shows the results.

The initial oxygen absorption speed and the maximum oxygen absorption amount of the oxygen absorbent molding G on an oxygen absorbent powder weight basis were equivalent to those of the oxygen absorbent H in the small sachet. Therefore, it is apparent that the oxygen-absorbing capability of the oxygen absorbent powder itself is not impeded even if it is molded into the oxygen absorbent molding according to the invention.

TABLE 1

| | | | | Initial Oxygen Absorption | |
|---|---|---|---|---|---|
| | | | | Speed on an Oxygen | |
| | | Form of | Principal Oxygen | Absorbent Powder Weight | Maximum Oxygen Absorption Amount |
| | Sample | Oxygen | Absorbent | Basis | on an Oxygen Absorbent Powder |
| | Name | Absorbent | Component | (ml/g - powder/day) | Weight Basis (ml/g - powder) |
| Example 1 | A | Sheet | Reduced iron powder | 201 | 295 |
| Example 2 | D | Sheet | Ascorbic acid | 58 | 71 |
| Example 3 | E | Tablet | Ascorbic acid | 56 | 69 |
| Example 4 | G | Tablet | Butadiene oligomer | 14 | 18 |
| Control 1 | B | Small Sachet | Reduced iron powder | 163 | 280 |
| Control 2 | F | Small Sachet | Ascorbic acid | 58 | 70 |
| Control 3 | H | Small Sachet | Butadiene oligomer | 14 | 18 |

TABLE 2

| | | | | Maximum |
|---|---|---|---|---|
| | | | Initial Oxygen | Oxygen |
| | | | Absorption Speed | Absorption |
| | | | on an Oxygen | Amount on a |
| | | Principal | Absorbent Powder | Molding |
| | | Oxygen | Weight Basis | Area Basis |
| | Sample | Absorbent | (ml/g - | (ml/cm² - |
| | Name | Component | powder/day) | molding) |
| Example 1 | A | Reduced | 191 | 34.2 |
| | | iron powder | | |
| Comparative | C | Reduced | 97 | 6.7 |
| Example 1 | | iron powder | | |

### Example 5

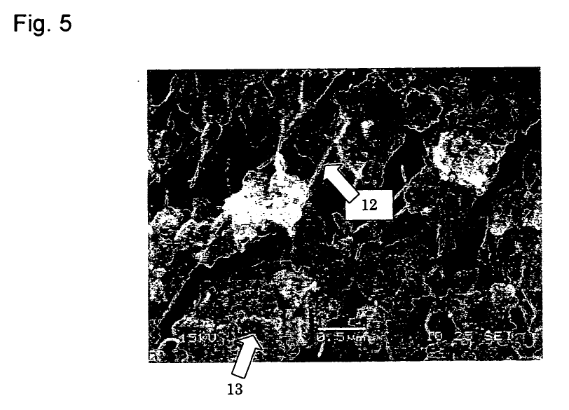

Vacuum calcination of calcium hydroxide powder (mean diameter: 1 μm) was conducted for one hour at a temperature of 500 degrees C., thereby obtaining calcium oxide. Subsequently, 0.96 g of the calcium oxide obtained above was mixed and impregnated with 0.24 g of liquid butadiene oligomer and 0.0038 g of cobalt stearate in a dry nitrogen atmosphere, and then 0.20 g of PTFE powder (mean diameter: 0.3 μm; melting point of 332 degrees C.) was added to the mixture obtained above, and the resultant mixture was well mixed at a temperature of 28 degrees C., using a mortar. The obtained agglomerate was rolled into sheet-form gas absorbent molding I (thickness: 250 μm). FIG. 5 shows a scanning electron microscope (SEM) photograph of the gas absorbent molding I. The oxygen absorbent molding I was a structure in which the gas absorbent composition, which was made of the calcium oxide dehydrating agent impregnated with the oxygen absorbent containing the liquid butadiene oligomer as its principal oxidizing component and the cobalt stearate as its assistant, was held together and united by the thermoplastic resin fibers (diameter: approximately 0.5 μm to 0.1 μm).

An area of size 3 cm×3 cm of the gas absorbent molding I was cut out. The cutout piece of the gas absorbent molding I was put, together with 200 ml of dry air, in an oxygen-and-moisture-impermeable bag, which was then sealed. The gas absorbent molding I in the oxygen-and-moisture-impermeable bag was stored at a temperature of 25 degrees C. The oxygen concentration within the bag was measured by gas chromatograph. The oxygen absorption amount of this gas absorbent molding after a lapse of 24 hours was 0.10 ml/cm²/day per sheet area.

An area of size 3 cm×3 cm of the gas absorbent molding I was cut out, which was stored in a 60% RH indoor environment at a temperature of 25 degrees C. The amount of weight increase of this gas absorbent molding I after a lapse of one hour was 17.5 wt %/h, and the amount of dehydration was 6.3 mg/cm²/h per sheet area.

A pressure sensitive adhesive double coated tape (adhesive layer thickness: 50 μm) was attached to the gas absorbent molding I, and an area of size 20 mm×24 mm was then cut out. The gas absorbent molding with the adhesive layer was attached to the inside surface of a stainless sealing cap for an organic electroluminescent element in a dry nitrogen atmosphere. An ultraviolet curable adhesive was applied to the periphery of the sealing cap, and a substrate having a luminescent structure was appressed to the adhesive-applied surface of the sealing cap. Subsequently, the substrate and the sealing cap were irradiated with an ultraviolet ray and bonded together, thereby sealing the luminescent structure and obtaining the organic electroluminescent element shown in FIG. 1.

Constant-current continuous operation was performed for 100 hours by continuously applying a direct current to the organic electroluminescent element at room temperature, using an ITO film as a positive electrode and Mg—Ag alloy as a negative electrode so that the current density would become 10 mA/cm². After 100 hours of constant-current continuous operation, the surface of the element was observed at a magnification of 50 times. There was no abnormality [dark spot or defective spot] in the organic electroluminescent element.

### Example 6

Vacuum calcination of calcium hydroxide powder (mean diameter: 1 μm) was conducted for one hour at a temperature of 500 degrees C., thereby obtaining calcium oxide. Subsequently, 0.96 g of the calcium oxide obtained above was mixed and impregnated with 0.24 g of liquid butadiene oligomer and 0.006 g of cobalt octoate-carrying calcium silicate (product name “Microcell E”; manufactured by Tokyo Diatomaceous Earth Industry K.K.); hereinafter referred to as “MCE”) (weight ratio of MCE:cobalt octoate=1:3) in a dry nitrogen atmosphere, and then 0.20 g of PTFE powder (mean diameter: 0.3 μm) was added to the mixture obtained above, and the resultant mixture was well mixed, using a mortar. The obtained agglomerate was rolled into sheet-form gas absorbent molding J (thickness: 250 μm) in the same manner as in Example 5. The oxygen-absorbing capability of the gas absorbent molding J was measured in the same manner as in Example 5. The oxygen absorption amount of this gas absorbent molding after a lapse of 24 hours was 0.50 ml/cm²/day per sheet area.

The moisture-absorbing capability of the gas absorbent molding J was measured in the same manner as in Example 5. The amount of weight increase of this gas absorbent molding J after a lapse of one hour was 17.2 wt %/h, and the amount of dehydration was 6.2 mg/cm²/h per sheet area.

An organic electroluminescent element was manufactured in the same manner as in Example 5, using the gas absorbent molding J, and constant-current continuous operation at 10 mA/cm² was performed for 100 hours. Then, the organic electroluminescent element was magnified and observed. There was no abnormality.

### Example 7

Vacuum calcination of calcium hydroxide powder (mean diameter: 1 μm) was conducted for one hour at a temperature of 500 degrees C., thereby obtaining calcium oxide. Subsequently, 0.96 g of the calcium oxide obtained above was mixed and impregnated with 0.24 g of liquid butadiene oligomer and 0.011 g of manganese naphthenate-carrying MCE (weight ratio of MCE:manganese naphthenate=1:2) in a dry nitrogen atmosphere, and then 0.20 g of PTFE powder (mean diameter: 0.3 μm; and a melting point at 332 degrees C.) was added to the mixture obtained above, and the resultant mixture was well mixed for 15 minutes at a temperature of 25 degrees C., using a mortar. The obtained agglomerate was rolled into sheet-form gas absorbent molding K (thickness: 250 μm) in the same manner as in Example 5.

The oxygen-absorbing capability of the gas absorbent molding K was measured in the same manner as in Example 5. The oxygen absorption amount of this gas absorbent molding after a lapse of 24 hours was 0.69 ml/cm²/day per sheet area.

The moisture-absorbing capability of the gas absorbent molding K was measured in the same manner as in Example 5. The amount of weight increase of this gas absorbent molding K after a lapse of one hour was 17.6 wt %/h, and the amount of dehydration was 6.4 mg/cm²/h per sheet area.

An organic electroluminescent element was manufactured in the same manner as in Example 5, using the gas absorbent molding K, and constant-current continuous operation at 10 mA/cm² was performed for 100 hours. Then, the organic electroluminescent element was magnified and observed. There was no abnormality.

### Example 8

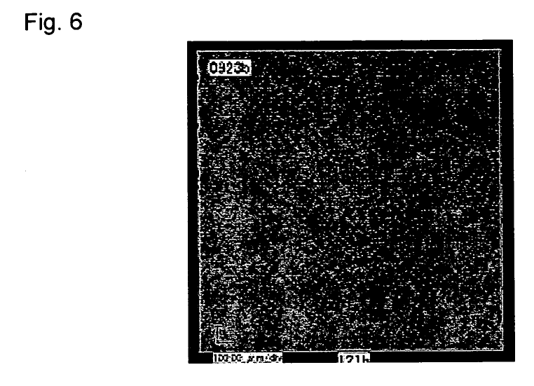

An organic electroluminescent element was made, using the gas absorbent molding K, in the same manner as in Example 5, except that the gas absorbent molding K with the adhesive layer was attached to the inside surface of a sealing cap made of glass for the organic electroluminescent element in a dry nitrogen atmosphere containing 0.3% oxygen. After constant-current continuous operation was conducted at 10 mA/cm² for 120 hours, the organic electroluminescent element was magnified and observed. FIG. 6 shows the result. There was no abnormality. Even in the atmosphere where oxygen existed in the sealing cap for the organic electroluminescent element, deterioration of the element was prevented by using the gas absorbent molding with the oxygen-absorbing capability.

### Comparative Example 2

An organic electroluminescent element was made in the same manner as in Example 5, except that the gas absorbent molding was not attached to the inside surface of the package. After constant-current continuous operation was conducted at 10 mA/cm² for 100 hours, the organic electroluminescent element was magnified and observed. It was found that prominent dark spots (element defective spots) were present.

### Comparative Example 3

A sheet desiccant (thickness: 250 μm) was obtained in the same manner as in Example 7, except that the liquid butadiene oligomer and the MCE carrying manganese naphthenate were not used.

The moisture-absorbing capability of the sheet desiccant was measured in the same manner as in Example 5. As a result, the amount of weight increase of this sheet desiccant after a lapse of one hour was 18.5 wt %/h, and the amount of dehydration was 6.8 mg/cm²/h per sheet area.

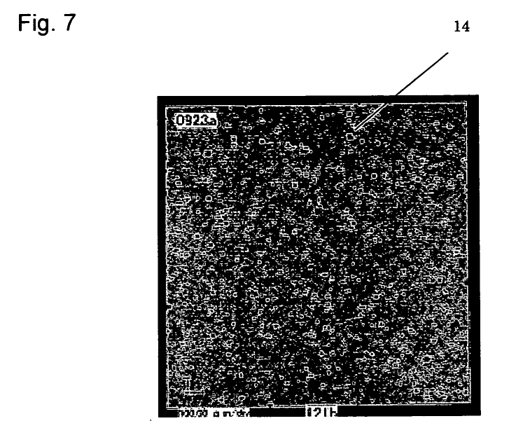

An organic electroluminescent element was made, using the sheet desiccant, in the same manner as in Example 8. After constant-current continuous operation was conducted at 10 mA/cm² for 120 hours, the organic electroluminescent element was magnified and observed. FIG. 7 shows the result. It was found that dark spots (element defective spots) were present. Even if moisture was removed by the desiccant, the organic electroluminescent element deteriorated due to the existence of oxygen in the sealing cap for the organic electroluminescent element.

1. An oxygen absorbent molding made of oxygen absorbent powder and a binder, wherein the binder is a fibrous resin.

2. The oxygen absorbent molding according to claim 1, wherein the fibrous resin is a resin fiberized by becoming subject to a shear force.

3. The oxygen absorbent molding according to claim 1, wherein the fibrous resin is fluororesin.

4. The oxygen absorbent molding according to claim 1, wherein the fibrous resin content in the oxygen absorbent molding is 1 to 50 wt %.

5. The oxygen absorbent molding according to claim 1, wherein the principal oxidizing component of the oxygen absorbent powder is iron powder with its surface coated with metal halide.

6. The oxygen absorbent molding according to claim 1, wherein the principal oxidizing component of the oxygen absorbent powder is oxygen absorbent resin powder.

7. The oxygen absorbent molding according to claim 1, wherein the principal oxidizing component of the oxygen absorbent powder is carrier powder carrying or impregnated with at least one type of oxygen absorbent selected from the group consisting of ascorbic acid and its salts, polyhydric alcohol, unsaturated fatty acid compounds, and chain hydrocarbon polymers with an unsaturated group.

8. A method for manufacturing an oxygen absorbent molding by; applying a shear force to and mixing a mixture of oxygen absorbent powder and a resin that can be fiberized by becoming subject to a shear force, at a temperature lower than the melting point of the resin; obtaining an agglomerate of the oxygen absorbent powder held together by the fibrous resin; and then forming the agglomerate into the oxygen absorbent molding.

9. A method for manufacturing an oxygen absorbent molding by applying a shear force to and mixing a mixture of carrier powder and a resin that can be fiberized by becoming subject to a shear force, at a temperature lower than the melting point of the resin; obtaining an agglomerate of the carrier powder held together by the fibrous resin; and then molding the agglomerate after having the carrier powder carry or be impregnated with an oxygen absorbent.

10. A method for manufacturing an oxygen absorbent molding by; applying a shear force to and mixing a mixture of carrier powder and a resin that can be fiberized by becoming subject to a shear force, at a temperature lower than the melting point of the resin; obtaining an agglomerate of the carrier powder held together by the fibrous resin; and then molding the agglomerate before having the carrier powder carry or be impregnated with an oxygen absorbent.

11. A gas absorbent molding made of a composition containing an oxygen absorbent and a dehydrating agent, and a binder wherein the binder is a fibrous resin.

12. The gas absorbent molding according to claim 11, wherein the oxygen absorbent is a composition containing, as its principal oxidizing component, an organic compound with an unsaturated group or a tertiary carbon atom.

13. The gas absorbent molding according to claim 11, wherein the oxygen absorbent is a composition containing, as its principal oxidizing component, an unsaturated fatty acid compound or a polymer with an unsaturated group.

14. The gas absorbent molding according to claim 11, wherein the dehydrating agent is at least one type selected from the group consisting of an alkali metal oxide, an alkall earth metal oxide, metal sulfate, and metal halide.

15. The gas absorbent molding according to claim 11, wherein the dehydrating agent is calcium oxide with a specific surface area of 10 to 200 m²/g.

16. The gas absorbent molding according to claims 11, further comprising an organic gas adsorbent.

17. The gas absorbent molding according to claims 11, wherein the fibrous resin content in the gas absorbent molding is 1 to 50 wt %.

18. The gas absorbent molding according to claims 11, wherein the fibrous resin is fluororesin.

19. An organic electroluminescent element having a luminescent structure made by stacking a transparent electrode, one or more organic compound layers containing an organic luminescent material, and a backside electrode, wherein the luminescent structure is sealed with a sealing component, and the gas absorbent molding described in claim 11 is placed near the luminescent structure inside the organic electroluminescent element.
